(19) United States
(12) Patent Application Publication
(10) Pub. No.: US 2009/0021414 A1
(43) Pub. Date: Jan. 22, 2009

(54) Remote Control for Mobile Machine, In Particular for Public Works Machine, Agricultural or Load-Handling Machine

(75) Inventors: Yves Marie Breton, Lyon (FR); Didier Merletti, Saint Sorlin (FR)

Correspondence Address: OLIFF & BERRIDGE, PLC, P.O. BOX 320850, ALEXANDRIA, VA, 22320-4850, US

(73) Assignee: BOSCH REXROTH D.S.I., VENISSIEUX (FR)

(21) Appl. No.: 11/918,349

(22) PCT Filed: Apr. 6, 2006
(86) PCT No.: PCT/FR2006/000763

§ 371 Date: Dec. 11, 2007

(30) Foreign Application Priority Data
May 18, 2005 (FR) 0504990

(51) Int. Cl. H04L 17/02

(52) U.S. Cl. 341/176

(57) ABSTRACT

The invention relates to a remote control of mobile engines, in particular working, agriculture and load-handling machines used for generating control signals to a client's device by means of communications means and comprising at least one sensor indicating the position of a control handle, a unit for processing signals transmitted by at least one sensor and an actuator for transmitting control signals processed by the processing unit to the client's device. The remote control comprises test means for introducing a signal derived from a test signal transmitted by the client's device into the processing unit input and is used for transmitting an information set to the client's device in response to the test signal, wherein said information set comprises at least one response signal corresponding to the processing of the signal derived from the test signal by the processing unit.

### BACKGROUND OF THE INVENTION

The subject of the present invention is a remote control, intended in particular for mobile machines, in particular for public works machines, agricultural or load-handling machines.

### DESCRIPTION OF THE PRIOR ART

A mobile machine remote control comprises, in a known manner, a movable handle that can move according to at least one degree of freedom with respect to a support, the motion of this handle allowing an operator to control at least one receiver device outside the remote control, also called a client device.

A remote control such as this comprises a sensor of the position of the handle, and a unit for processing the signals of the sensor, making it possible to generate a control signal destined for the client device.

Such types of devices are satisfactory for the control of receiver apparatus under the normal conditions of use.

It is however desirable to provide means for making the remote control secure, by guaranteeing the redundancy of the information. In particular, this redundancy makes it possible to identify erroneous information in the case of a malfunction of a sensor and/or the processing unit.

Consequently, it is known to provide at least two sensors of the position of the handle, thereby enabling the information originating from the sensors to be made secure. Thus, when the information given by the two sensors is not consistent, a malfunction is detected.

It is also known to provide two processing units, so as to make the control signals originating from these units secure. Thus, when the information given by the two processing units is not consistent, a malfunction is detected.

It should be noted that the components of the remote control must comply with constraints regarding minimum proportions and simplicity of mounting on the remote control.

Though the sensors can be of restricted size, the redundancy of these sensors not substantially complicating the structure of the remote control, it is apparent on the other hand that putting two processing units in place in the remote control significantly complicates the realization of the remote control, and also increases its cost appreciably.

### SUMMARY OF THE INVENTION

Consequently, the aim of the present invention is to provide a remote control in which the malfunctions due to the processing unit can be detected, without making it necessary to put two processing units in place within the remote control.

For this purpose, the present invention relates to a remote control for mobile machine, in particular for public works machine, agricultural or load-handling machine, intended to generate control signals towards a client device, by way of communication means, the remote control comprising:
a movable control handle that can move according to at least one degree of freedom with respect to the body of the remote control,
at least one sensor of the position of the control handle,
a unit for processing the signals emitted by the at least one sensor,
an actuator, intended to transmit control signals, processed by the processing unit to the client device,

characterized in that it comprises test means intended to introduce a signal derived from a test signal emitted by the client device as input for the processing unit, and in that it is designed to emit, towards the client device, an information set, in response to the test signal, comprising at least one response signal, corresponding to the processing of the signal derived from the test signal by the processing unit.

These arrangements make it possible to check the operation of the processing unit, at the level of the client device, by comparing the test signal emitted and the signal corresponding to the processing of the test signal by the processing unit, without requiring the presence of two processing units, but of simple test means constituting a loop as input for the processing means.

These arrangements enable the information originating from the remote control to be made secure while keeping the structure of the latter simple. They make it possible to exploit the presence of means of supervision at the level of the client device, this device not being subject to the same constraints relating to its proportions.

These arrangements make it possible to comply with the standards of type IEC61508N relating to remote control, in particular section SIL2 thereof.

Advantageously, the information set, emitted in response to the test signal, moreover comprises at least one control signal corresponding to the processing of the signal of the sensors by the processing unit.

Advantageously, the test signal is a digital signal.

According to an embodiment, the test means comprise:
means for emitting an analog signal on the basis of the test signal
means for filtering the analog signal emitted.

Advantageously, the processing unit comprises at least one analog/digital converter.

According to an embodiment, the means for emitting a signal towards the filtering means on the basis of the test signal comprise means for generating a signal of pulse width modulation type.

Advantageously, the filtering means comprise a low-pass filter.

According to an embodiment, the remote control comprises additional means for monitoring the processing unit, comprising:
a component for checking the supply voltage of the unit, and/or
a component for checking the timing frequency of the operations in the processing unit.

Advantageously, the remote control comprises at least two sensors for each degree of freedom of the handle.

The present invention also relates to a method of checking the operation of a processing unit of a mobile machine remote control, in particular for public works machine, agricultural or load-handling machine, intended to generate control signals towards a client device, by way of communication means, the remote control comprising:
a movable control handle that can move according to at least one degree of freedom with respect to the body of the remote control,
at least one sensor of the position of the control handle,
a unit for processing the signals emitted by the at least one sensor,
an actuator, intended to transmit control signals, processed by the processing unit to the client device,

method comprising the steps consisting in,

at the level of a client device:
emitting a test signal destined for the processing unit,

at the level of the remote control:
producing a signal derived from the test signal emitted by the client device
introducing the derived signal as input for the processing unit,
processing the signal derived from the test signal as a sensor signal at the level of the processing unit,
emitting an information set, comprising at least one signal corresponding to the processing by the processing unit, of the signal derived from the test signal, towards the client device, and

at the level of the client device:
comparing the test signal and the response signal.

Advantageously, the test signal is a digital signal.

According to a mode of implementation, the production of a signal derived from the test signal is carried out by:
deriving an analog signal on the basis of the test signal
filtering the analog signal thus emitted.

According to a mode of implementation, the information set comprises moreover, at least one signal corresponding to the processing of the signal of the sensors by the processing unit.

Advantageously, at the level of the client device, the information set emitted by the remote control is waited for in a determined time interval after emission of the test signal.

Advantageously, the method comprises a step, at the level of the processing unit, consisting in multiplexing the sensor signals and signals derived from the test signal, and in processing the multiplexed signal with processing means, in particular to carry out an analog/digital conversion.

According to a mode of implementation, the detection of the position of the handle is carried out by two distinct sensors.

Advantageously, at least one part of the processing is carried out, within the processing unit, in a redundant manner by at least two routines whose instructions and/or data are recorded in two distinct memory areas of the processing unit.

According to a mode of implementation, a first routine processes the signals of a first sensor and the signal derived from the test signal, and a second routine processes the signals of a second sensor and the signal derived from the test signal.

### BRIEF DESCRIPTION OF THE DRAWINGS

In any event, the invention will be well understood with the aid of the description which follows, with reference to the appended diagrammatic drawing, representing by way of nonlimiting example, an embodiment of a remote control according to the invention.

FIG. 1 is a view in partial section of a remote control according to an embodiment.

FIG. 2 is a diagrammatic representation of a system formed of a remote control and of a client device connected by communication means.

FIG. 3 is a representation of the characteristic of the output signal of the sensors of the remote control of FIG. 1, as a function of the position of the handle.

FIG. 4 is a block diagram of the processing components of the remote control of FIG. 1.

FIG. 5 is a flowchart of the processing operations performed by the processing unit of the remote control of FIG. 1.

FIG. 6 is a diagram of the temporal ordering of the communication between the remote control of FIG. 1 and a client device.

FIG. 7 is a table describing a data frame dispatched by a client device to the remote control of FIG. 1.

FIG. 8 is a table describing a data frame dispatched by the remote control of FIG. 1 to a client device.

### DESCRIPTION OF THE PREFERRED EMBODIMENTS

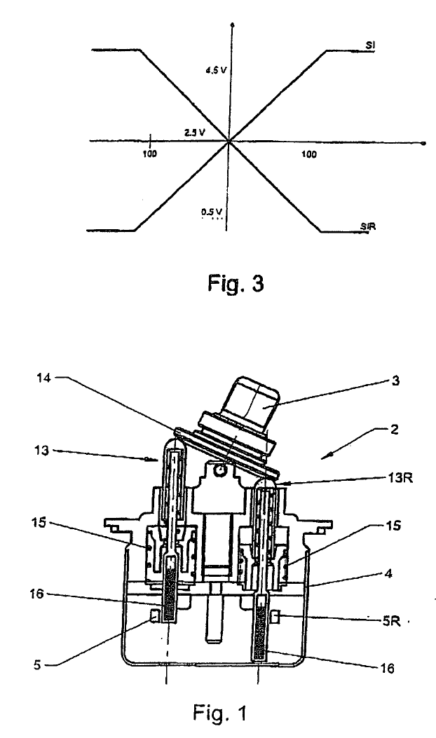

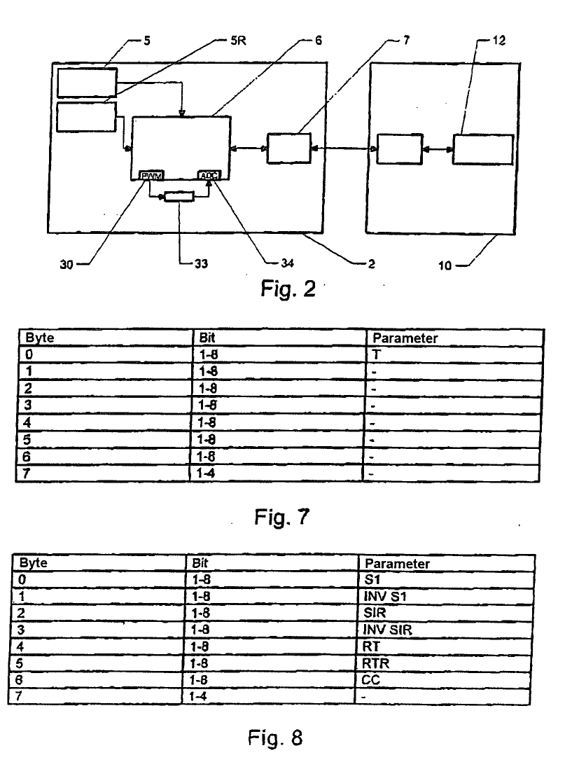

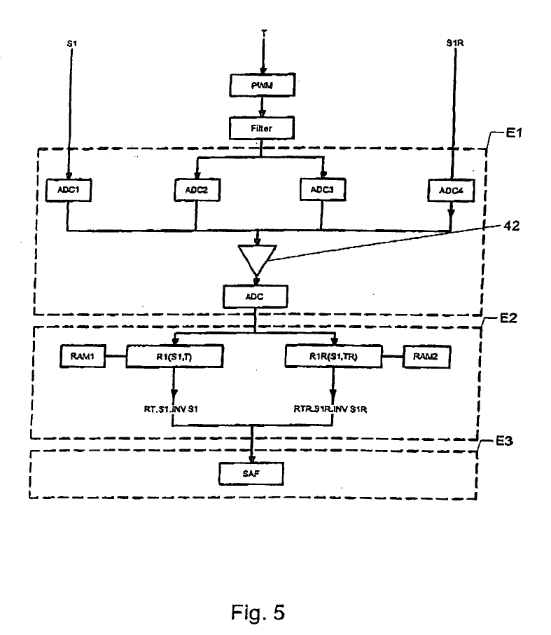

According to an embodiment represented in FIGS. 1 to 8, a remote control 2 for mobile machine according to the invention comprises:
a movable control handle 3 that can move according to at least one degree of freedom with respect to the body 4 of the remote control,
two position sensors 5, 5R of the position of the control handle 3,
a unit 6 for processing the signals emitted by the sensors 5, 5R,
an actuation part or actuator 7, intended to transmit control signals to the client system.

The control signals are transported by way of communication means 9, constituted for example of a fieldbus of CAN bus type towards a client device 10 comprising at least means of supervision 12.

For the mechanical part, represented in FIG. 1, the remote control 1 for mobile machines comprises, as described in document FR 2 857 489, for each degree of freedom of the handle 3, two pushers 13, 13R mounted sliding in the body 4.

The handle 3 is mounted rockably with respect to the body 4, and controls, by way of a transverse skirt 14 simply supported on the upper end of the pushers 13, 13R, the to-and-fro motions of these two pushers 13, 13R situated on either side of the handle 3.

First elastic restoring means 15 urge each pusher 13, 13R towards its out position in such a way that they possess an inherent upward motion, and follow the motions of the handle in all its rocking positions, between a depressed position and an out position of the pusher 13, 13R.

These arrangements make it possible to convert the rocking motion of the handle 3 into a linear motion of each pusher 13, 13R.

The sensors 5, 5R detect the position of each of the pushers 13, 13R, thereby making it possible to ascertain the position of the handle.

Preferably, the sensors 5, 5R are sensors without mechanical contact of the Hall-effect sensor type, mounted in the body 4 of the remote control. Each pusher includes a foot comprising a magnet 16, moving past the sensor between the depressed and out positions of each pusher 13, 13R.

It should be noted that a single pusher and a single sensor are sufficient to ascertain the position of the handle in all its rocking positions.

The presence of two pushers and of two sensors therefore makes it possible to obtain redundant information for a given axis or degree of freedom.

Each sensor 5, 5R provides, as a function of the position of the handle 3 and therefore of the pusher with which it is associated, a signal S1, S1R.

This signal S1, S1R can for example be given in the form of an electrical voltage signal, whose value lies between two extreme bounds of 0.5 and 5 V, a middle value of 2.5 V corresponding to the neutral position of the handle.

This signal S1, S1R, precisely indicating the position of the handle 3, is dispatched to the processing unit 6.

It is of course possible to apply these arrangements to a remote control 2 comprising more than one degree of freedom. In particular, for a remote control comprising a two-axis handle, four pushers and four sensors are used, thus providing four signals S1, S1R, S2, S2R.

We shall subsequently illustrate the behavior of the system for a single degree of freedom, but it is obvious that the latter can be used for any number of degrees of freedom.

Given the arrangement of the pushers on either side of the handle for a given axis, two crossed signals are obtained, as is represented in FIG. 3, for a first axis, corresponding to the signals S1 and S1R.

For example, it is noted that for a position of the handle oriented 100% in a first direction, the value of the signal S1 is 4.5 V while the value of the signal S1R is 0.5 V.

When the handle is in its neutral position, the two sensors 13, 13R deliver one and the same value of the signals S1, S1R, equal to 2.5 V.

It should be noted that spans of values above 4.5 V and below 0.5 V, make it possible to detect causes of malfunction such as wear, cutoff of the circuit or a short-circuit.

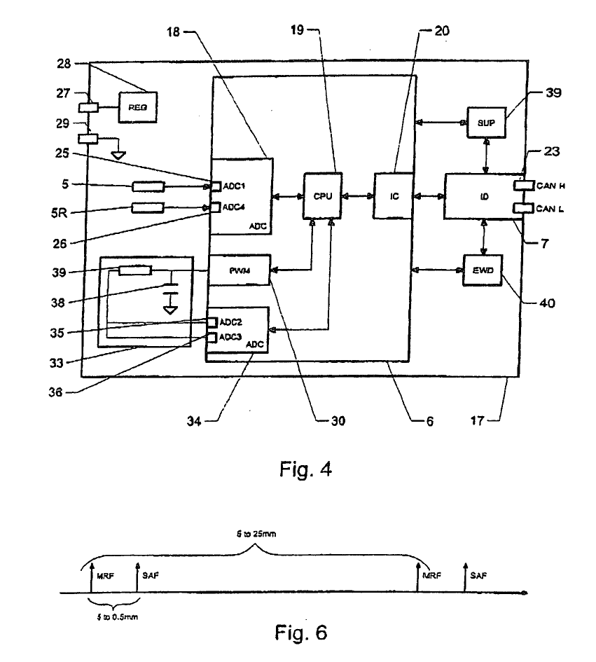

As represented in FIG. 4, the processing unit 6 consists of a part of an electronic card 17, in particular a microcontroller.

This microcontroller 6 comprises:
an analog/digital converter ADC, intended to receive the signals originating from the sensors through a first group of inputs, represented at 18.
a microprocessor CPU, represented at 19, intended for processing and routing the information on the microcontroller,
an interface controller IC, represented at 20, intended for communication with the actuator 7.

The microprocessor CPU is linked to the other components by internal communication means of the microcontroller 6, of bus type.

The actuator 7 consists of an interface pilot ID, which allows in particular amplification of the signals provided by the interface controller IC. For example, the level of the signal at the output of the interface controller is of the order of 1 mA, and the interface pilot amplifies the level of this signal up to 20 mA, to communicate it via the bus 9.

The actuator 7 is linked to the bus for emission and reception by two links CANH and CANL represented at 23 and 24.

By virtue of the elements received above, the signals S1 and S1R are received at the level of the analog/digital converter ADC at 18, by two inputs ADC1 and ADC4, referenced as 25 and 26. The signals S1 and S1R are thus transformed from analog into digital signals S1d and S1Rd.

The microprocessor CPU makes it possible to perform complementary processing operations on the signals, for example to put in place signal curves or ramps.

The output signals S1s and S1Rs thus obtained are thereafter provided to the interface controller IC, which transmits them to the actuator 7, itself transmitting this signal, constituting a control signal to the client device 10 via the communication means 9, consisting of the fieldbus CAN.

The card as a whole is supplied via a power source via an input 27, connected for example to a voltage regulator REG, represented at 28. For example, this regulator makes it possible to check that the supply for the microcontroller is effected in a voltage band of 5V.

Moreover, the card exhibits a common reference of electrical potential 29.

According to a characteristic of the invention, the microcontroller moreover comprises a set of test means, making it possible to deduce a response signal RT on the basis of a test setpoint value T.

The digital test setpoint value T is communicated by the means of supervision 12 of the client system, by way of the communication bus 9.

This setpoint value T is received by the actuator 7, which transmits it to the interface controller IC, and is routed thereafter by the microprocessor CPU to the test means.

The test means comprise in particular:
means for generating a signal of pulse width modulation PWM type, represented at 30, on an output 32 of the microcontroller 6, on the basis of a digital test setpoint value T, and
a filter 33, for example of low-pass type, making it possible to generate a continuous signal on the basis of the pulse width modulation signal.

A second input group 34 of the analog/digital converter ADC, of which two inputs ADC2 and ADC3, represented at 35 and 36, take the analog signal value as output from the filter 33.

The filter 33 can for example consist of a resistor 37 in series between the terminals of the filter and a bypass to the common reference comprising a capacitor 38.

The test means thus make it possible to provide an analog signal value originating from the filtering, processed as a signal value originating from a sensor, by the converter ADC, then during the processing operations performed by the microprocessor CPU, and during the transfer by the interface controller IC and the actuator.

The signal obtained corresponding to a response signal RT is thereafter returned to the means of supervision 12 of the client device 10 with the control signals of the sensors, S1 and S1R, by way again of the interface controller IC, of the actuator 7, then of the communication bus 9, as we shall explain in detail below.

The electronic card 17 also comprises complementary means of checking the operation of the microcontroller forming the processing unit, consisting of:
a component VSUP, bearing the reference 39 for checking the microcontroller supply voltage and
a component EWD, bearing the reference 40, for checking the timing frequency of the operations in the microcontroller.

These components are capable of halting the operation of the actuator 7 if an anomaly is noted relating to the parameters checked.

FIG. 4 makes it possible to illustrate the organization of the processing operations performed on the signals present at the input of the analog/digital converter ADC, up to the shaping of data frames capable of being transmitted to the client system by the interface controller IC and the actuator 7.

The signals S1, S1R, T originating respectively from a first and a second sensor 5, 5R, and from the filter 33 are present on the following inputs of the analog/digital converter ADC:
ADC1, for S1,
ADC2 and ADC3 for T, and
ADC4 for S1R.

In a first step E1, the set of these signals S1, S1R, T are multiplexed by a multiplexing component 42 to form the subject of one and the same analog/digital conversion processing by the converter ADC. The multiplexing can be performed by a dedicated component or by the microprocessor.

In a second operation E2, the conversion of the multiplexed signal is performed by the converter ADC.

In a third step E3, within the microprocessor, the additional processing operations are performed on the digital data obtained on the basis of the signals S1, T, S1R. These processing operations are performed by two, redundant, calculation routines R1 and R1R whose identical instructions are stored in two separate parts RAM1 and RAM2 of the memory of the microprocessor CPU.

The routine R1 processes the data arising from the signals S1 and T, originating from the inputs ADC1 and ADC2 of the converter, and the routine R1R processes the data arising from the signals S1R and T, originating from the inputs ADC1 and ADC3 of the converter.

As output, the routine R1 provides digital data derived from the signals:
T
S1, and
A signal INVS1, corresponding to a bitwise digital inversion of S1.

The routine R1R of the digital data derived from the signals:
T, that we shall denote by TR, to mark the difference with the signal obtained by the routine R1
S1R,
A signal INVSLR, corresponding to a bitwise digital inversion of S1R.

In a fourth step E4, the data obtained at E3 are formatted in the form of a frame SAF, for dispatch to the client system, by the interface controller IC and the interface pilot of the actuator 7.

This frame comprises the following data:
S1: the value of the signal originating from a first sensor 5, after processing
INVS1: the bitwise digital inversion of S1.
S1R: the value of the signal originating from a redundant second sensor 5R, after processing
INVS1R: the bitwise digital inversion of S1R.
RT: the response value, corresponding to the value derived from T, measured at ADC2, and obtained after the processing operations by the processing unit.
RTR: the response value, corresponding to the value derived from T, measured at ADC3, and obtained after the processing operations by the processing unit.

The frame moreover comprises a cyclic counter CC making it possible to identify said frame with respect to the preceding and succeeding frames.

The protocol for communication between the means of supervision 12 of the client device 10 and the processing unit consisting of the microcontroller 6 is of master/slave type. The means of supervision 12 of the client device constitute the master, and the processing unit 6 of the remote control is the slave.

The means of supervision dispatch a synchronous request in the form of a master request frame MRF, and wait for a response in the form of a slave response frame SAF, in a determined time window, from the emission of the request frame.

An exemplary ordering of the frame transmissions is illustrated in FIG. 6. It is apparent in this example that the response of the processing unit must reach the client device supervision means in 0.5 ms, and that the request frames are dispatched by these supervision means at an interval of between 5 and 25 ms.

The synchronous mode described makes it possible to avoid communication errors and avoid confusions between two responses to two emitted request frames.

The master request frame MRF comprises the test setpoint value T, and the slave response frame SAF comprises the data of the signals RT, S1, INVS1, RTR, S1R, INVSR such as detailed above. FIGS. 7 and 8 describe an exemplary structure for these frames.

It is thus possible for the client device supervision means to compare the test setpoint value T dispatched with the values RT and RTR received, to identify whether the operation of the microcontroller is satisfactory, the signals received RT and RTR having been processed by all the components of the microcontroller, comprising redundant elements.

It is also possible to compare the values of S1 and INVS1, respectively of S1R and INVSLR, so as to monitor the proper functioning of the operations carried out by the calculation routines.

Finally the comparison of the signals S1 and S1R makes it possible to monitor the proper functioning of the sensors 5, 5R.

As goes without saying, the invention is not limited to the preferential embodiments described above, by way of nonlimiting example; on the contrary it embraces all variants thereof.

1. A remote control for mobile machine, in particular for public works machine, agricultural or load-handling machine, intended to generate control signals towards a client device, by way of communication means, the remote control comprising:
a movable control handle that can move according to at least one degree of freedom with respect to the body of the remote control,
at least one sensor of the position of the control handle,
a unit for processing the signals emitted by the at least one sensor,
an actuator, intended to transmit control signals, processed by the processing unit to the client device,
which comprises test means intended to introduce a signal derived from a test signal emitted by the client device as input for the processing unit, and which is designed to emit, towards the client device, an information set, in response to the test signal, comprising at least one response signal, corresponding to the processing of the signal derived from the test signal by the processing unit.

2. The remote control as claimed in claim 1, wherein the information set, emitted in response to the test signal moreover comprises at least one control signal corresponding to the processing of the signal of the sensors by the processing unit.

3. The remote control as claimed in claim 1, wherein the test signal is a digital signal.

4. The remote control as claimed in claim 1, wherein the test means comprise:
means for emitting an analog signal on the basis of the test signal
means for filtering the analog signal emitted.

5. The remote control as claimed in claim 1, wherein the processing unit comprises at least one analog/digital converter.

6. The remote control as claimed in claim 4, wherein the means for emitting a signal towards the filtering means on the basis of the test signal comprise means for generating a signal of pulse width modulation type.

7. The remote control as claimed in claim 4, wherein the filtering means comprise a low-pass filter.

8. The remote control as claimed in claim 1, which comprises additional means for monitoring the processing unit, comprising:
a component for checking the supply voltage of the unit, and/or
a component for checking the timing frequency of the operations in the processing unit.

9. The remote control as claimed in claim 1, which comprises at least two sensors for each degree of freedom of the handle.

10. A method of checking the operation of a processing unit of a mobile machine remote control, in particular for public works machine, agricultural or load-handling machine, intended to generate control signals towards a client device, by way of communication means, the remote control comprising:
a movable control handle that can move according to at least one degree of freedom with respect to the body of the remote control,
at least one sensor of the position of the control handle,
a unit for processing the signals emitted by the at least one sensor,
an actuator, intended to transmit control signals, processed by the processing unit to the client device,
method comprising the steps consisting in,
at the level of a client device:
emitting a test signal destined for the processing unit,
at the level of the remote control:
producing a signal derived from the test signal emitted by the client device
introducing the derived signal as input for the processing unit,
processing the signal derived from the test signal as a sensor signal at the level of the processing unit,
emitting an information set, comprising at least one response signal corresponding to the processing by the processing unit, of the signal derived from the test signal, towards the client device,
at the level of the client device:
comparing the test signal and the response signal.

11. The method as claimed in claim 10, wherein the test signal is a digital signal.

12. The method as claimed in claim 10, wherein the production of a signal derived from the test signal is carried out by:
deriving an analog signal on the basis of the test signal
filtering the analog signal thus emitted.

13. The method as claimed in claim 10, wherein the information set comprises moreover, at least one signal corresponding to the processing of the signal of the sensors by the processing unit.

14. The method as claimed in claim 11, wherein, at the level of the client device, the information set emitted by the remote control is waited for in a determined time interval after emission of the test signal.

15. The method as claimed in claim 11, which comprises a step, at the level of the processing unit, consisting in multiplexing the sensor signals and signals derived from the test signal, and in processing the multiplexed signal with processing means, in particular to carry out an analog/digital conversion.

16. The method as claimed in claim 10, wherein the detection of the position of the handle is carried out by two distinct sensors.

17. The method as claimed in claim 10, wherein at least one part of the processing is carried out, within the processing unit, in a redundant manner by at least two routines whose instructions and/or data are recorded in two distinct memory areas of the processing unit.

18. The method as claimed in claim 17, wherein a first routine processes signals of a first sensor and the signal derived from the test signal, and a second routine processes signals of a second sensor and the signal derived from the test signal.
